(19) United States
(12) Patent Application Publication
(10) Pub. No.: US 2024/0010547 A1
(43) Pub. Date: Jan. 11, 2024

(54) GILLESPITE GLASS-CERAMICS

(71) Applicant: CORNING INCORPORATED, Corning, NY (US)

(72) Inventors: George Halsey Beall, Big Flats, NY (US); Lisa Anne Tietz Moore, Corning, NY (US); Michelle Marie Wallen, Hammondsport, NY (US)

(21) Appl. No.: 18/035,327

(22) PCT Filed: Nov. 5, 2021
(86) PCT No.: PCT/US2021/058148

§ 371 Date: May 4, 2023

Related U.S. Application Data
(60) Provisional application No. 63/112,797, filed on Nov. 12, 2020.

(51) Int. Cl. C03C 10/00

(52) U.S. Cl. CPC C03C 10/0009; C03C 2214/20; C03C 2214/16

(57) ABSTRACT

One embodiment of the disclosure relates to a glass-ceramic with a phase assemblage comprising gillespite crystalline phase (BaFeSi₄O₁₀). According to some embodiments the glass-ceramic comprises at least one of: (a) barium silicate phase, (b) silica crystalline phase, (c) iron silicate phase.

### CROSS-REFERENCE TO RELATED APPLICATIONS

This application claims the benefit of priority under 35 U.S.C. § 119 of U.S. Provisional Ser. No. 63/112,797 filed on Nov. 12, 2020, the content of which is relied upon and incorporated herein by reference in its entirety.

### BACKGROUND

The disclosure relates generally to glass-ceramic articles and more particularly to glass-ceramic articles comprising gillespite crystalline phase (BaFeSi₄O₁₀).

No admission is made that any reference cited herein constitutes prior art. Applicant expressly reserves the right to challenge the accuracy and pertinency of any cited documents.

### SUMMARY

One embodiment of the disclosure relates to a glass-ceramic with a phase assemblage comprising gillespite crystalline phase (BaFeSi₄O₁₀).

According to some embodiments the glass-ceramic comprises at least one of:
(a) barium silicate phase,
(b) silica crystalline phase,
(c) iron silicate phase.

According to some embodiments the glass-ceramic comprises: (i) 60 mol %-85 mol % SiO₂; (ii) 4 mol %-30 mol % BaO; and (iii) 4% mol %-30 mol % Fe₂O₃.

According to some embodiments the glass-ceramic comprises Pt, for example 2 to 100 ppm-mole Pt.

According to some embodiments the glass-ceramic comprises is an alkali-free glass-ceramic.

According to some embodiments the glass-ceramic has a coefficient of thermal expansion (CTE) that is less than 10 ppm/° C. at a temperature range between 25° C. and 300° C., for example less than 8.5 ppm/° C.

According to some embodiments the glass-ceramic described above has the crystal content that comprises at least 50% by weight of the glass-ceramic, wherein BaFeSi₄O₁₀ constitutes the principal crystal phase, the gillespite crystals in the crystal content being all smaller than about 50 microns in cross-section and being formed through the crystallization in situ of a glass body, the glass body comprising, by mole %, of: 60-85 SiO₂, 4-30 BaO, 4-25 Fe₂O₃, and at least one metal oxide from the group consisting of MgO, ZnO, CaO, and SrO, wherein the ratio (MgO+ZnO+CaO+SrO)/BaO is ≤1.

According to some embodiments the glass-ceramic described above has the crystal content that comprises at least 50% by weight of the glass-ceramic, wherein BaFeSi₄O₁₀ constitutes the principal crystal phase, the gillespite crystals in the crystal content being all smaller than about 50 microns in cross-section and being formed through the crystallization in situ of a glass body, the glass body comprising, by mole %, of: 60-85 SiO₂, 4-30 BaO, 4-25 Fe₂O₃, and at least one metal oxide from the group consisting of MgO, ZnO, CaO, and SrO; and 0-2% of other components; wherein the ratio (MgO+ZnO+CaO+SrO)/BaO is ≤1, and 0-2 mole % of other components. According to some embodiments the glass-ceramic comprises no more than 0.2 mole % of other components.

According to some embodiments all of the gillespite crystals in the crystal content are smaller than 30 microns in cross-section (or diameter). According to some embodiments wherein all of the gillespite crystals in the crystal content are between 3 microns and 25 microns in cross-section (or diameter). According to some embodiments all of the gillespite crystals in the crystal content are between 5 microns and 20 microns in cross-section (or diameter).

According to some embodiments the glass-ceramic described above has the crystal content that comprises at least 70% by weight of the glass-ceramic According to some embodiments the glass-ceramic described above has the crystal content that comprises at least 75% by weight of the glass-ceramic. According to some embodiments the glass-ceramic has the crystal content that comprises at least at least 80% by weight of the glass-ceramic. According to some embodiments the glass-ceramic has the crystal content that comprises at least at least 90% by weight of the glass-ceramic. According to some embodiments the glass-ceramic has the crystal content that comprises at least at least 95% by weight of the glass-ceramic.

According to some embodiments a glass-ceramic comprises: (i) gillespite; and (ii) 60-mol % SiO₂, 2-28 mol % BaO, and 4-28 mol % Fe₂O₃. According to some embodiments the glass-ceramic comprises 4-25 mol % Fe₂O₃. According to some embodiments the glass-ceramic comprises 4-20 mol % Fe₂O₃. According to some embodiments the glass-ceramic comprises 4-17 mol % Fe₂O₃. According to some embodiments the glass-ceramic comprises 4-15 mol % Fe₂O₃. According to some embodiments the glass-ceramic comprises 0-2% mole % of other components (e.g., Pt).

According to some embodiments a glass-ceramic comprises SiO₂, BaO, Fe₂O₃, and one or more of MgO, ZnO, CaO, SrO, or B₂O₃, in which gillespite is one of the crystalline phases.

According to some embodiments the concentration of B₂O₃ (mol %) is ≤10.

According to some embodiments, the molar ratio of MgO:BaO is ≤0.55. According to some embodiments the molar ratio of ZnO:BaO is ≤0.45. According to some embodiments which the molar ratio of CaO:BaO is ≤1. According to some embodiments the molar ratio of SrO:BaO is ≤1.

According to some embodiments, a method of making the glass-ceramic(s) described above comprises utilizing a precursor glass, wherein the [Fe²⁺]/[total Fe] ratio of the precursor glass is in the range 0.5-1. According to some embodiments the [Fe²⁺]/[total Fe] ratio of the precursor glass is in the range of 0.6-1.

According to some embodiments, a method of making the glass-ceramic article where in the crystal content thereof is at least 50% by weight of the a glass-ceramic article, wherein the crystal content comprises gillespite crystals that are all smaller than 50 microns in cross section (or diameter), and wherein BaFeSi₄O₁₀ constitutes the principal crystal phase, the method comprises: (a) melting a glass-forming batch consisting essentially, by mole on the oxide basis, of about 60-85 SiO₂, 4-30 BaO, 4-25 Fe₂O₃, the sum of BaO and SiO₂, constituting at least 72.5% of the batch; and up to 20% by mole total of at least one metal oxide selected from the group consisting of SrO, CaO, ZnO, MgO, Na₂O, K₂O, Rb₂O, Cs₂O wherein the ratio (MgO+ZnO+CaO+SrO)/BaO is ≤1 and the sum (Na₂O+K₂O+Rb₂O+Cs₂O) is 0-2 mole %; (b) simultaneously cooling the melt at least below the transformation point thereof and shaping a glass article therefrom; (c) heating the glass article between about 700° C. and 900° C. for a period of time sufficient to attain the desired crystallization, thereby forming a glass-ceramic article; and then (d) cooling the glass-ceramic article to room temperature.

According to some embodiments, a method of making the glass-ceramic article where in the crystal content thereof is at least 50% by weight of the a glass-ceramic article, wherein the crystal content comprises gillespite crystals that are all smaller than 50 microns in diameter, and wherein BaFeSi₄O₁₀ constitutes the principal crystal phase, the method comprises: (a) melting a glass-forming batch consisting essentially, by mole on the oxide basis, of about 65-75 SiO₂, 7.5-30 BaO, 4-12 Fe₂O₃, the sum of BaO and SiO₂, constituting at least 72.5% of the batch, and up to 20% by mole total of at least one metal oxide selected from the group consisting of SrO, CaO, ZnO, MgO, Na₂O, K₂O, Rb₂O, Cs₂O, wherein the ratio (MgO+ZnO+CaO+SrO)/BaO is ≤1 and the sum (Na₂O+K₂O+Rb₂O+Cs₂O) is 0-2 mole %; (b) simultaneously cooling the melt at least below the transformation point thereof and shaping a glass article therefrom; (c) heating the glass article between about 700° C. and 900° C. for a period of time sufficient to attain the desired crystallization, thereby forming a glass-ceramic article; and then (d) cooling the glass-ceramic article to room temperature.

According to some embodiments the time sufficient to attain the desired crystallization ranges about 2 to 6 hours (e.g., 2 hours, 2.5 hours, 3 hours, 3.5 hours, 4 hours, 4.5 hours, 5 hours, 5.5 hours, 6 hours, or therebetween).

According to some embodiments, the method(s) described above utilizes Pt as a nucleating agent. According to some embodiments, the method(s) described above utilizes a reducing agent in the glass-forming batch. According to some embodiments, the reducing agent may be graphite, sugar, urea, silicon, or iron.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 illustrates XRD (X-ray diffraction) spectra of exemplary glass-ceramics embodiments;

FIG. 2 illustrates an exemplary embodiment of a glass-ceramic (Ex. 10) comprising fine-grained microstructures comprising reddish crystals.

FIG. 3 is a scanning electron micrograph of the polished surface of glass-ceramic Ex. 10.

FIG. 4 illustrates XRD spectra of four glass-ceramics embodiments.

FIG. 5 is a diagram that illustrates compositions of gillespite-containing glass-ceramics in mole fraction.

FIG. 6 illustrates thermal expansion data for exemplary compositions.

FIG. 7 illustrates thermal expansion data for exemplary compositions.

### DETAILED DESCRIPTION

The glass-ceramic described herein comprises gillespite (BaFeSi₄O₁₀).

According to some embodiments the glass-ceramic comprises at least one of:
(a) barium silicate phase,
(b) silica crystalline phase,
(c) iron silicate phase.

According to some embodiments the glass-ceramic comprises: (i) 60 mol %-85 mol % SiO₂; (ii) 4 mol %-30 mol % BaO; and (iii) 4% mol %-30 mol % Fe₂O₃.

According to some embodiments the glass-ceramic comprises is an alkali-free glass-ceramic.

According to some embodiments the glass-ceramic has a coefficient of thermal expansion (CTE) that is less than 10 ppm/° C. at a temperature range between 25° C. and 300° C., for example less than 8.5 ppm/° C.

According to some embodiments the glass-ceramic described above has the crystal content that comprises at least 50% by weight of the glass-ceramic, wherein BaFeSi₄O₁₀ constitutes the principal crystal phase, the crystals being all smaller than about 50 microns in cross-section and being formed through the crystallization in situ of a glass body, the glass body comprising, by mole %, of: 60-85 SiO₂, 4-30 BaO, 4-30 Fe₂O₃ (e.g., 4-28%) and at least one metal oxide from the group consisting of MgO, ZnO, CaO, and SrO, wherein the ratio (MgO+ZnO+CaO+SrO)/BaO is ≤1. According to some embodiments a glass-ceramic comprises: (i) gillespite; and (ii) 60-75 mol % SiO₂, 2-28 mol % BaO, and 4-28 mol % Fe₂O₃. According to some embodiments a glass-ceramic comprises 4-25 mol % Fe₂O₃. According to some embodiments a glass-ceramic comprises 4-20 mol % Fe₂O₃. According to some embodiments a glass-ceramic comprises 4-17 mol % Fe₂O₃. According to some embodiments a glass-ceramic comprises 4-15 mol % Fe₂O₃.

According to some embodiments a glass-ceramic comprises SiO₂, BaO, Fe₂O₃, and one or more of MgO, ZnO, CaO, SrO, or B₂O₃, in which gillespite is one of the crystalline phases. According to some embodiments the concentration of B₂O₃ (mol %) is ≤10.

According to some embodiments, the molar ratio of MgO:BaO is ≤0.55. According to some embodiments the molar ratio of ZnO:BaO is ≤0.45. According to some embodiments which the molar ratio of CaO:BaO is ≤1. According to some embodiments which the molar ratio of SrO:BaO is ≤1.

Various embodiments will be further clarified by the following examples.

The glass-ceramics disclosed herein were made using compositions and melting conditions presented here and in Tables below.

### EXAMPLE 1

The exemplary glasses in Table 1 all had the batched composition BaO-0.5Fe₂O₃-4SiO₂. Batches of glass, 500-600 g, were made from sand, barium carbonate, iron oxalate, and PtCl. Examples 1-4 were made with Pt concentrations of 5 ppm-mol, 25 ppm-mol, 50 ppm-mol, and 100 ppm-mol, respectively.

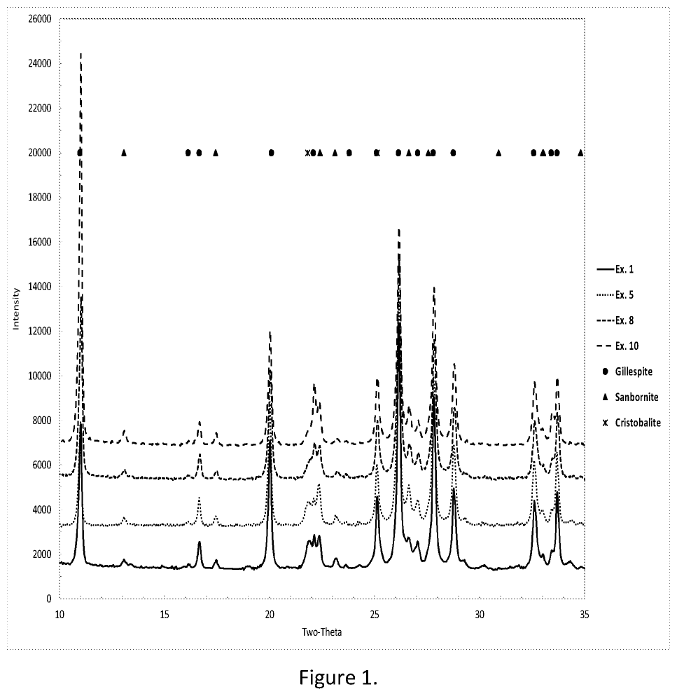

Melting was done in either high purity silica or Pt crucibles in either air or nitrogen in an electric furnace. The crucibles were either loaded into the furnace at room temperature and heated to 1600° C. at the heating rates shown in Table 1, or loaded directly into the furnace at 1600° C. After 2 hours at the temperature of 1600° C., the glass melts were removed from the furnace and poured onto a steel table, allowing them to cool. Pieces of the glasses were cerammed under nitrogen (≤2000 ppm O₂) by heating the cooled glass at a rate of 5° C./min to 800° C. and holding for 4 hours at 800° C. to form the glass-ceramic. The analyzed compositions of all the glasses in Table 1 are in the range (mol %): 73-75 SiO_{2, 18}-19 BaO, and 8-9 Fe₂O₃, and the XRD (X-ray diffraction) spectra of some of the resultant glass-ceramics from Table 1 are shown in FIG. 1.

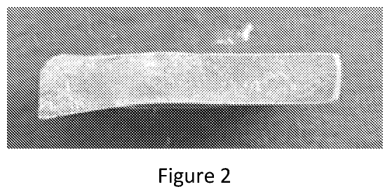

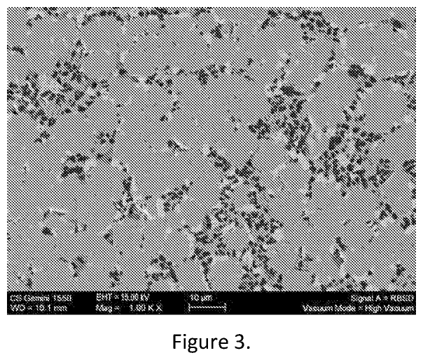

All of the glass-ceramics of Table 1 had fine-grained microstructures comprising reddish crystals (See, for example, FIGS. 2 and 3). The phase assemblages of the resultant exemplary glass-ceramics comprised primarily gillespite (BaFeSi₄O₁₀) and sanbornite (BaSi₂O₅). Some of the embodiments also included small amounts of cristobalite (SiO₂) and barium silicate sometimes appeared. The exception was comparative example (Comp. Ex. 1) where the glass, which was melted in air by heating from room temperature to 1600° C., did not form a glass-ceramic (it contained no internal crystals). By contrast, Example 10, which was melted in air but loaded directly into the furnace at 1600° C., formed the fine-grained glass-ceramic, with at least 50% crystal content by weight.

Glass compositions and Fe redox ratios (Fe²⁺:total Fe, by weight) were measured by ICP (Inductively Coupled Plasma) and chemical oxygen demand. In cases where the glass-ceramic was formed, the Fe redox ([Fe²⁺]/total Fe, by wt.) in the precursor glass was >0.5, while in Comp. Ex. 1 it was <0.5. It is believed that the heating rate of the batch to the melt temperature, the melt temperature, and the choice of an iron-containing batch material can be advantageously adjusted to set the resultant Fe redox ratio in the glass to >0.5. Preferably, the melt temperature is at least 1600° C., the heating rate to the melt temperature is ≥10° C./min, and the iron-containing batch material is primarily or completely in an oxidation state <3+, such as iron oxalate. In some cases, it may be preferred to conduct the melting in a furnace atmosphere with a low partial pressure of oxygen, such a ≤2000 ppm.

A method for further increasing Fe redox is by the addition of a reducing agent to the batch. For example, Examples 6-9 which were batched with 1 g graphite, 2 g sugar, 5 g urea, and 4.5 g silicon metal, respectively. The Fe redox ratios of the glasses were >0.8 when a reductant was added to the batch. It is believed that a high proportion of Fe²⁺ ions, as indicated by an iron redox ratio >0.5, is preferred for achieving desired amounts of gillespite formation, because the crystal, BaFeSi₄O₁₀, comprises iron cations in the +2 oxidation state (Fe²⁺).

The iron oxide concentrations are reported as mol % Fe₂O₃ although it exists in both the Fe²⁺ and Fe³⁺ oxidation states in the glass.

Our data shows that a fine-grained (i.e., having grain size of ≤20 microns) gillespite-sanbornite glass-ceramic can be produced when the Fe redox of the glass is >0.5. Preferably, the Fe redox of the glass is >0.6, and even more preferably >0.7, for example up to 1. This is shown, for exemplary embodiments 3, and 5-10 in Table 1. Furthermore, Pt in a concentration greater than about 2 ppm-mol acts as an effective nucleating agent, as shown by Examples 1-4.

TABLE 1
Exemplary BaO—0.5Fe₂O₃—4SiO₂ glass-ceramics.

| | Example No. | | | | | | | | | | |
|---|---|---|---|---|---|---|---|---|---|---|---|
| | | | | | | | | | | | Comp |
| | 1 | 2 | 3 | 4 | 5 | 6 | 7 | 8 | 9 | 10 | Ex. 1 |
| SiO2 | 72.9 | 73.3 | 73.1 | 73.4 | | 72.8 | 74.1 | 74.0 | 74.6 | 72.5 | |
| BaO | 18.1 | 18.0 | 18.0 | 17.9 | | 18.4 | 17.5 | 17.5 | 17.7 | 18.8 | |
| Fe2O3 | 8.8 | 8.5 | 8.5 | 8.5 | | 8.7 | 8.4 | 8.4 | 7.7 | 8.3 | |
| Na2O | 0.2 | 0.2 | 0.3 | 0.2 | | | | | | 0.4 | |
| Pt (batched) | 5 | 25 | 50 | 100 | 50 | 50 | 50 | 50 | 50 | 50 | 50 |
| ppm-mol | | | | | | | | | | | |
| Reductant | none | none | none | none | none | graphite | sugar | urea | Si metal | none | none |
| Melting | | | | | | | | | | | |
| Conditions | | | | | | | | | | | |
| Atmosphere | N2 | N2 | N2 | N2 | N2 | N2 | N2 | N2 | N2 | air | air |
| Crucible | silica | silica | silica | silica | silica | silica | silica | silica | silica | Pt | silica |
| Heating Rate | 27 | 27 | 27 | 27 | 10 | 27 | 27 | 27 | 27 | loaded at | 15 |
| (° C./min) | | | | | | | | | | 1600° C. | |
| Glass | | | | | | | | | | | |
| Total Fe as | | | 15.7 | | 15.7 | 16.2 | 15.8 | 15.8 | 14.4 | 15.7 | 15.6 |
| Fe2O3 (wt %) | | | | | | | | | | | |
| Fe + 2 as | | | 10.6 | | 10.8 | 13.2 | 11.8 | 11.7 | 13.5 | 11.0 | 6.6 |
| FeO (wt. %) | | | | | | | | | | | |
| Fe + 3 as | | | 3.9 | | 3.8 | 1.5 | 2.6 | 2.8 | 0 | 3.5 | 8.2 |
| Fe2O3 (wt. %) | | | | | | | | | | | |
| Fe + 2/total Fe | | | 0.75 | | 0.76 | 0.91 | 0.83 | 0.82 | 1.00 | 0.78 | 0.47 |
| Glass-Ceramic | | | | | | | | | | | |
| (800° C. 4 h) | | | | | | | | | | | |
| Appearance | fine | fine | fine , | fine | fine | fine red | fine red | fine red | fine | fine | glassy, |
| | crystals, | crystals, | crystals | crystals, | crystals, | crystals | crystals | crystals | crystals, | crystals, | dark |
| | red hue | red hue | red hue | red hue | red hue | | | | red hue | red hue | brown |
| Phases | gillespite, | gillespite, | gillespite, | gillespite, | gillespite, | gillespite, | gillespite, | gillespite, | gillespite, | gillespite, | glass |
| | sanbornite, | sanbornite, | sanbornite, | sanbornite, | sanbornite, | sanbornite | sanbornite, | sanbornite, | sanbornite, | sanbornite | |
| | cristobalite | cristobalite | cristobalite | cristobalite | cristobalite, | | cristobalite | cristobalite | cristobalite | | |
| | | | | | Ba3Si5O13 | | | | | | |

The crystal content of the glass-ceramic articles comprises of at least 50% by weight of the article, at least 60%, at least 70%, at least 75%, and at least 90%. or at least 95%. The gillespite crystals are all preferably smaller than 50 microns in diameter, for example about microns or less in diameter, and preferably between 5 and 20 microns in diameter.

### EXAMPLE 2

Table 2 shows example embodiments of compositions within the BaO—Fe₂O₃—SiO₂ composition space that produce gillespite-containing glass-ceramics. The iron oxide concentration is reported as mol % Fe₂O₃ although it exists in both the Fe²⁺ and Fe³⁺ oxidation states in the glass.

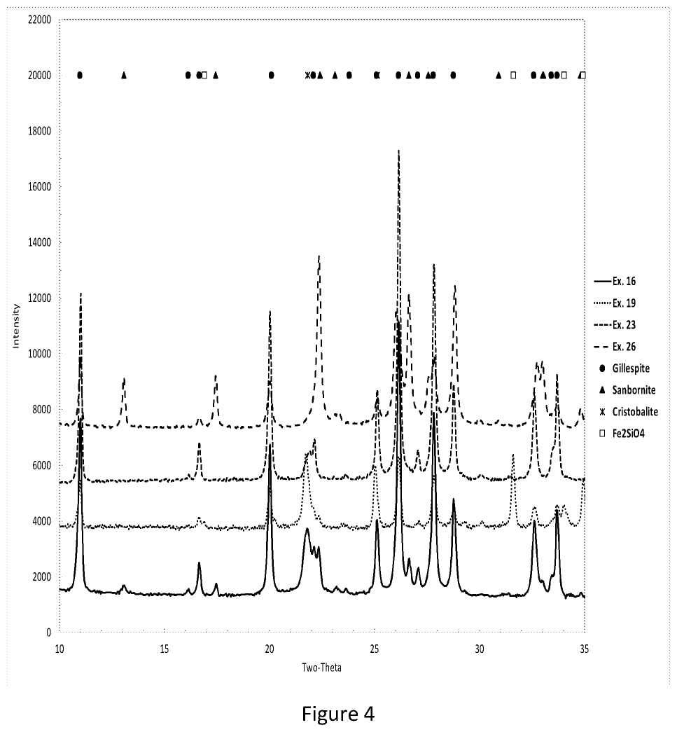

The exemplary glasses of this embodiment lie within the composition range (mol %): 60-85 SiO₂, 4-30 BaO, 1-25 Fe₂O₃ with 2-100 ppm-mol Pt. More specifically, the glasses in Table 2 lie within the composition range (mol %): 65-85 SiO₂, 5-30 BaO, 1.5-23 Fe₂O₃ with 20-50 ppm-mol Pt added as a nucleating agent. The batches were made using the same raw materials as above and melted under the same conditions as Example 3 or Example 10 (Table 1). Ceramming was done under the same conditions as above. XRD spectra of four of the exemplary glass-ceramics in Table 2 are shown in FIG. 4. All of the glass-ceramics comprised gillespite and one or more secondary phases such as: BaSi₂O₅ (sanbornite) and other barium silicate phases, SiO₂ (cristobalite, quartz), and Fe₂SiO₄. The phase assemblage of the glass-ceramic can be changed by varying the amounts of barium oxide, iron oxide, and silica in the glass.

TABLE 2
Glass-ceramic compositions (mol %)

| | Example No | | | | | | | | | |
|---|---|---|---|---|---|---|---|---|---|---|
| | 11 | 12 | 13 | 14 | 15 | 16 | 17 | 18 | 19 | |
| SiO2 | 78.1 | 70.1 | 76.6 | 71.1 | 69.5 | 80.3 | 84.4 | 70.8 | 72.4 | |
| BaO | 14.9 | 20.3 | 9.2 | 13.9 | 25.2 | 13.4 | 10.5 | 19.6 | 5.2 | |
| Fe203 | 7.1 | 9.6 | 14.0 | 14.7 | 5.3 | 6.3 | 5.1 | 9.6 | 22.5 | |
| Pt (batched) ppm-mol | 20 | 20 | 20 | 20 | 20 | 20 | 50 | 50 | 50 | |
| Glass | | | | | | | | | | |
| Total Fe as Fe2O3 (wt %) | | | 27.1 | 26.8 | | | | | | |
| Fe + 2 as FeO (wt. %) | | | 21.7 | 20.6 | | | | | | |
| Fe + 3 as Fe2O3 (wt. %) | | | 3 | 3.9 | | | | | | |
| Fe + 2/total Fe | | | 0.89 | 0.86 | | | | | | |
| Glass-Ceramic | | | | | | | | | | |
| (800° C. 4 h) | | | | | | | | | | |
| Appearance | fine red | fine | large | large | fine | fine red | gray, | fine | fine gray | |
| | crystals | crystals | crystals | crystals | crystals | crystals | crumbly | crystals | crystals | |
| Phases | gillespite, | gillespite, | gillespite, | gillespite, | gillespite, | gillespite, | gillespite, | gillespite, | gillespite, | |
| | sanbornite, | sanbornite | cristobalite | quartz | sanbornite, | sanbornite, | sanbornite, | sanbornite | sanbornite, | |
| | cristobalite | | | | quartz | cristobalite, | cristobalite | | cristobalite, | |
| | | | | | | BaSi5O11 | | | Fe2SiO4 | |
| | Example No. | | | | | | | | | |
| | | | | | | | | | | Comp. |
| | 20 | 21 | 22 | 23 | 24 | 25 | 26 | 27 | 28 | Ex. 2 |
| SiO2 | 68.6 | 70.4 | 71.9 | 73.7 | 69.1 | 67.2 | 69.4 | 65.4 | 66.3 | 68.6 |
| BaO | 20.9 | 19.7 | 20.5 | 15.8 | 18.7 | 23.7 | 25.8 | 28.5 | 29.6 | 29.6 |
| Fe2O3 | 9.7 | 9.2 | 7.0 | 9.8 | 11.2 | 8.4 | 4.5 | 5.7 | 3.8 | 1.9 |
| Pt (batched) ppm-mol | 25 | 25 | 25 | 25 | 25 | 25 | 25 | 25 | 25 | 50 |
| Glass | | | | | | | | | | |
| Total Fe as Fe2O3 (wt %) | 17.4 | 16.7 | 12.9 | 18.4 | 20.2 | 14.8 | 8.03 | 9.8 | 6.55 | |
| Fe + 2 as FeO (wt. %) | 8.51 | 8.15 | 6.94 | 11 | 10.4 | 7.75 | 4.64 | 5.08 | 3.78 | |
| Fe + 3 as Fe2O3 (wt. %) | 7.94 | 7.61 | 5.19 | 5.81 | 8.67 | 6.18 | 2.87 | 4.13 | 2.35 | |
| Fe + 2/total Fe | 0.54 | 0.54 | 0.60 | 0.68 | 0.57 | 0.58 | 0.64 | 0.58 | 0.64 | |
| Glass-Ceramic | | | | | | | | | | |
| (800° C. 4 h) | | | | | | | | | | |
| Appearance | fine | fine | fine | fine | fine | fine | fine | fine | fine | fine |
| | crystals | crystals | crystals | crystals | crystals | crystals | crystals | crystals | crystals | crystals |
| Phases | gillespite, | gillespite, | gillespite, | gillespite, | gillespite, | gillespite, | gillespite, | gillespite, | gillespite, | sanbornite, |
| | sanbornite | sanbornite | sanbornite | cristobalite | sanbornite | sanbornite | sanbornite | sanbornite | sanbornite | cristobalite |

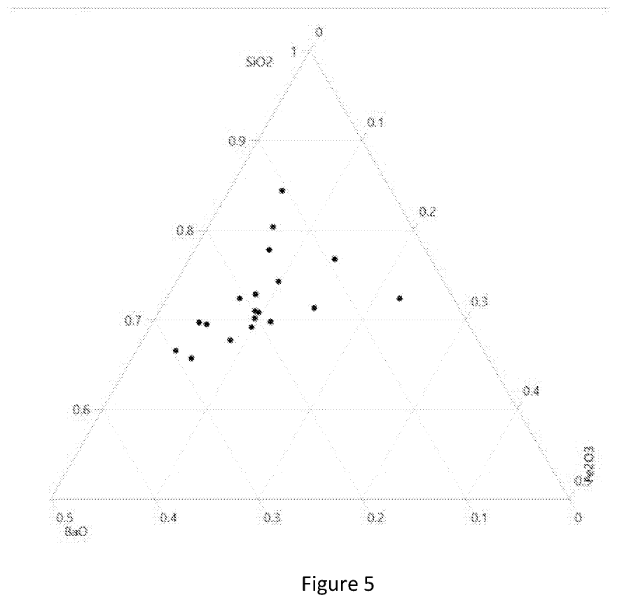

The range of exemplary glass compositions from Tables 1 and 2 which form gillespite glass-ceramics is illustrated in FIG. 5.

The wide composition range and different phase assemblages obtainable in gillespite glass-ceramics means the properties of the glass-ceramics can be tailored. Properties of selected glass-ceramics from Table 2 are shown in Table 3. Glass-ceramic Ex. 10 has a high resistivity, and it is non-magnetic, as shown by its frequency-independent magnetic susceptibility equal to 1. Fracture toughness was measured by the Chevron Notch Short Bar method according to ASTM E1304. The apparent fracture toughness (K_{1c}) of the glass-ceramic is similar to Macor® machinable glass-ceramic. Young's modulii ranging from about 70 to 88 GPa and shear modulii from about 28 to 35 GPa were obtained. Vicker's Hardness (200 g) ranged from 350 to 525 (e.g., 360-500).

According to at least some embodiments, the average coefficient of thermal expansion (CTE) between 25° C. of and 300° C. of the glass-ceramics embodiments are in the range 3.4 to 10.8 ppm/° C. According to some embodiments, the coefficient of thermal expansion is less than 10 ppm/C in the temperature range between 25° C. and 300° C. According to some embodiments, the coefficient of thermal expansion is less than 8.5 ppm/C in the temperature range between 25° C. and 300° C. The lowest CTE occurred near the stoichiometric gillespite composition, Ex. 10. Thus, the glass-ceramics embodiments described herein are capable of exhibiting CTE's similar to or much lower than those of binary barium silicate glass-ceramics, which are typically >10 ppm/° C. within a temperature range between 25° C. and 300° C.

TABLE 3
Room temperature properties of glass-ceramics

| Example No. | 10 | 23 | 24 | 26 | 28 |
|---|---|---|---|---|---|
| Density (g/cc) | 3.318 | 3.28 | 3.463 | 3.526 | 3.708 |
| CTE (ppm/° C.) | 3.4 | 4.3 | 4.2 | 8.4 | 10.8 |
| Vicker's Hardness, 200 g | 357 ± 15 | 475 ± 11 | 426 ± 17 | 468 ± 13 | 522 ± 8 |
| Young's Modulus (GPa) | 70.4 | 77.84 | 80.46 | | 87.91 |
| Shear Modulus (GPa) | 27.72 | 30.61 | 31.03 | | 35.16 |
| Poisson's Ratio | 0.271 | 0.272 | 0.296 | | 0.249 |
| Fracture Toughness, K1C | 1.49 ± 0.14 | | | | |
| (Mpa · √m) | | | | | |
| Volume resistivity, 35° C. | 3.6E+05 | | | | |
| (ohm · cm) | | | | | |
| Magnetic Permeability, | 1 | | | | |
| 0.1-11 MHz | | | | | |

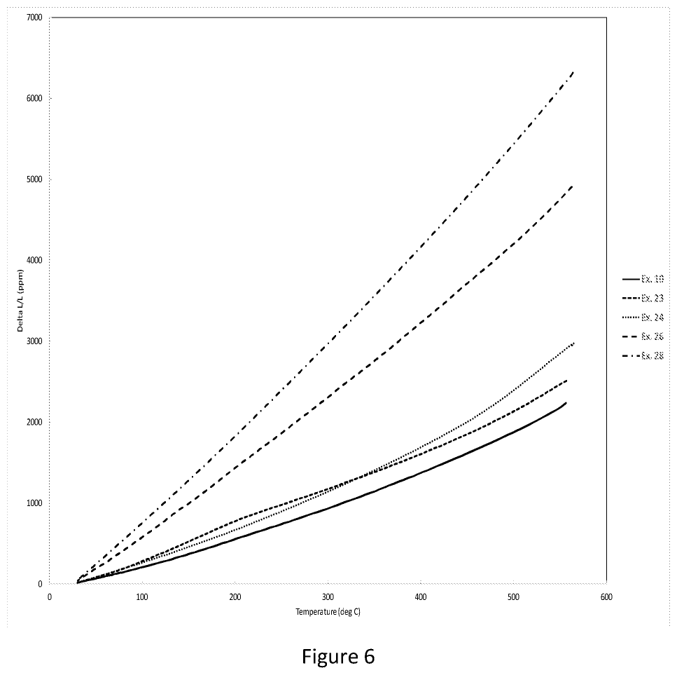

FIG. 6 illustrates thermal expansion data for the glass-ceramics in Table 3. More specifically, FIG. 6 illustrates the thermal expansion curves (ΔL/L) over a temperature range between 0 and 600° C. measured on cooling from the maximum temperature.

Table 4, below, illustrates average coefficients of thermal expansion (25° C. to temperature, Temp.), where Temp. is 50° C. up to 550° C.

TABLE 4
Thermal expansion coefficients (in ppm/° C.)

| | Example No. | | | | |
|---|---|---|---|---|---|
| Temp. (° C.) | 10 | 23 | 24 | 26 | 28 |
| 50 | 2.67 | 3.21 | 3.40 | 7.49 | 9.72 |
| 75 | 2.69 | 3.41 | 3.48 | 7.54 | 9.94 |
| 100 | 2.76 | 3.72 | 3.52 | 7.69 | 10.05 |
| 125 | 2.85 | 4.00 | 3.58 | 7.87 | 10.15 |
| 150 | 2.95 | 4.20 | 3.65 | 7.96 | 10.24 |
| 175 | 3.05 | 4.35 | 3.73 | 8.05 | 10.33 |
| 200 | 3.16 | 4.43 | 3.81 | 8.18 | 10.42 |
| 225 | 3.23 | 4.41 | 3.90 | 8.24 | 10.53 |
| 250 | 3.29 | 4.35 | 3.98 | 8.28 | 10.63 |
| 275 | 3.34 | 4.30 | 4.07 | 8.34 | 10.72 |
| 300 | 3.40 | 4.27 | 4.15 | 8.39 | 10.80 |
| 325 | 3.46 | 4.26 | 4.23 | 8.45 | 10.87 |
| 350 | 3.52 | 4.25 | 4.32 | 8.48 | 10.95 |
| 375 | 3.59 | 4.26 | 4.41 | 8.54 | 11.02 |
| 400 | 3.66 | 4.28 | 4.50 | 8.61 | 11.10 |
| 425 | 3.73 | 4.31 | 4.60 | 8.66 | 11.18 |
| 450 | 3.80 | 4.35 | 4.71 | 8.74 | 11.26 |
| 475 | 3.87 | 4.41 | 4.85 | 8.78 | 11.35 |
| 500 | 3.95 | 4.49 | 5.03 | 8.84 | 11.45 |
| 525 | 4.04 | 4.59 | 5.24 | 8.93 | 11.54 |
| 550 | | | 5.42 | 9.05 | 11.65 |

The gillespite glass-ceramics Examples 1 and 2 embodiments were black, red, or purple in color. A red powder was obtained by crushing the Ex. 11 glass-ceramic and a bright purple powder by crushing the Ex. 9 glass-ceramic. Such powders could be used as pigments in, for example, colored glazes.

### EXAMPLE 3

The gillespite glass-ceramics can be obtained when MgO, ZnO, CaO, SrO, or B₂O₃ are added to the compositions. The batching, melting of the glasses were performed in a similar manner to that described above. MgO was batched as magnesium oxide, ZnO was batched as zinc oxide, CaO was batched as limestone, SrO was batched as strontium carbonate, and B₂O₃ was batched as boric oxide. Samples of the glasses were cerammed at 800° C. for 4 hours under nitrogen.

It is noted, that cost reduction may be achieved by substitution of less expensive materials for some of the BaO.

Table 5 illustrates exemplary embodiments of MgO- and ZnO-containing gillespite glass-ceramics. The compositions are given in terms of batched oxides in mol %. Gillespite appeared in compositions with up to 35% of the BaO replaced with MgO (Ex. 29-31). With 50% MgO substitution for BaO, the sample was highly glassy and did not comprise gillespite. With up to 30% replacement of BaO with ZnO a gillespite-containing glass-ceramic was obtained, Ex. 33. With a higher ZnO substitution for BaO, the material no longer comprised gillespite.

The average coefficient of thermal expansion (CTE) between 25 and 300° C. for the Ex. 32 glass-ceramic was 3.0 ppm/° C.

TABLE 5
Compositions of gillespite glass-ceramics MgO- and ZnO-containing (mol % in batch)

| Example No. | 29 | 30 | 31 | 32 | 33 |
|---|---|---|---|---|---|
| SiO2 | 72.7 | 72.7 | 72.7 | 72.7 | 72.7 |
| MgO | 4.5 | 5.5 | 6.4 | | |
| ZnO | | | | 4.5 | 5.5 |
| BaO | 13.6 | 12.7 | 11.8 | 13.6 | 12.7 |
| Fe2O3 | 9.1 | 9.1 | 9.1 | 9.1 | 9.1 |
| Pt, ppm-mol | 50 | 50 | 50 | 50 | 50 |
| Glass-Ceramic (800° C. 4 h) | | | | | |
| Phases | gillespite, | gillespite | gillespite | gillespite, | gillespite, |
| | FeSiO3 | | | FeSiO3 | sanbornite, |
| | | | | | BaZn2Si2O7, |
| | | | | | cristobalite |
| CTE (ppm/° C.) | 3.6 | | | 3.0 | 4.4 |

Table 6 shows compositions in which CaO (Ex. 34, 35) or SrO (Ex. 36, 37) was substituted for 25% or 50% of the BaO in the stoichiometric gillespite composition. In all four cases, the glass-ceramics comprised gillespite and a secondary phase. In the CaO-containing glass-ceramics, the secondary phases were a ferrosilicate and cristobalite. In the SrO-containing glass-ceramics, the secondary phases were sanbornite and cristobalite and. The CTE's of the 25%-substituted glass-ceramics (Ex. 34 and 36) were around 5 ppm/° C. Table 6 also shows three glass-ceramics prepared with B₂O₃ added “on top” of the stoichiometric gillespite composition (Ex. 38, 39, 40). In all three cases, the phase assemblage comprised gillespite as the major phase. No secondary crystalline phase appeared in the glass-ceramic with the lowest B₂O₃ addition (Ex. 38), while quartz appeared as a minor phase in the higher boron compositions (Ex. 39, 40). The SrO- and B₂O₃-containing glass-ceramics exhibited very strong red colors, most likely due to the high concentration of gillespite (red) crystals and only colorless minor phases.

TABLE 6
Compositions of gillespite glass-ceramics CaO—, SrO—, and B₂O₃-containing
(mol % in batch)

| | Example No. | | | | | | |
|---|---|---|---|---|---|---|---|
| | 34 | 35 | 36 | 37 | 38 | 39 | 40 |
| SiO2 | 72.7 | 72.7 | 72.7 | 72.7 | 71.0 | 69.3 | 67.7 |
| B2O3 | | | | | 2.4 | 4.8 | 7.0 |
| CaO | 4.5 | 9.1 | | | | | |
| SrO | | | 4.5 | 9.1 | | | |
| BaO | 13.6 | 9.1 | 13.6 | 9.1 | 17.7 | 17.3 | 16.9 |
| Fe2O3 | 9.1 | 9.1 | 9.1 | 9.1 | 8.9 | 8.7 | 8.5 |
| Pt, ppm-mol | 50 | 50 | 50 | 50 | 50 | 50 | 50 |
| molar ratio | CaO:BaO = 0.33 | CaO:BaO = 1.0 | SrO:BaO = 0.33 | SrO:BaO = 1.0 | | | |
| Glass-Ceramic (800° C. 4 h) | | | | | | | |
| Phases | gillespite, | gillespite, | gillespite, | gillespite, | gillespite | gillespite, | gillespite, |
| | Fe1.3Ca0.7Si2O6 | Fe1.3Ca0.7Si2O6, | cristobalite | sanbornite, | | quartz | quartz |
| | | cristobalite | | cristobalite | | | |
| CTE (ppm/° C.) | 4.9 | | 5.0 | | | | |

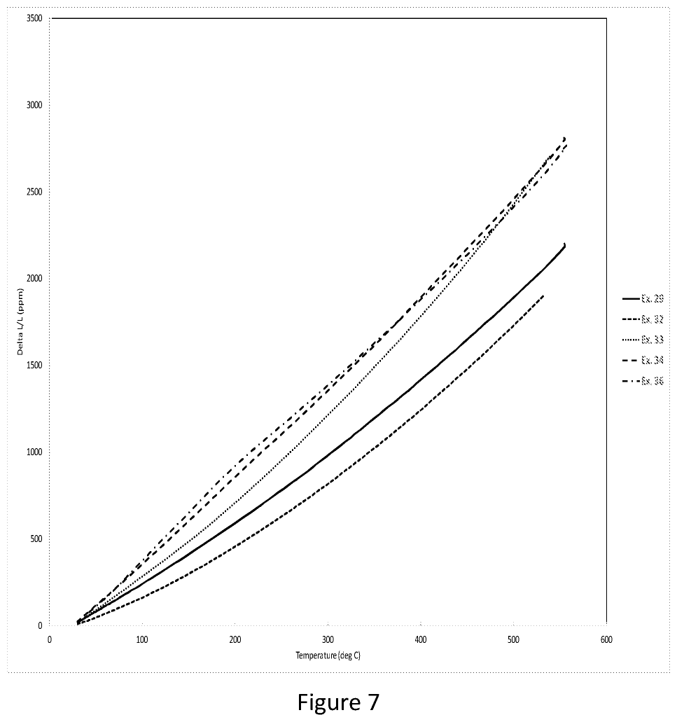

FIG. 7 illustrates thermal expansion data for exemplary glass-ceramics of Tables 5 and 6. More specifically, FIG. 7 illustrates the thermal expansion curves (ΔL/L) over a temperature range between 0 and 600° C. measured on cooling from the maximum temperature.

We have discovered that certain tertiary BaO—Fe₂O₃—SiO₂ glasses nucleate and crystallize into a glass-ceramic comprising gillespite (BaFeSi₄O₁₀) as the major phase. For example, we discovered that according to some embodiments, a method of making the glass-ceramic(s) described above comprises utilizing a precursor glass, wherein the [Fe²⁺]/[total Fe] ratio of the precursor glass is in the range 0.5-1. According to some embodiments,

According to some embodiments, a method of making the glass-ceramic(s) described above comprises utilizing a precursor glass, wherein the [Fe²⁺]/[total Fe] ratio of the precursor glass is in the range of 0.5-1.

According to some embodiments, a method of making the glass-ceramic article where in the crystal content thereof is at least 50% by weight of the a glass-ceramic article, wherein the crystal content comprises gillespite crystals that are all smaller than 50 microns in cross section (or diameter), and wherein BaFeSi₄O₁₀ constitutes the principal crystal phase, the method comprises: (a) melting a glass-forming batch consisting essentially, by mole on the oxide basis, of about 60-85 SiO₂, 4-30 BaO, 4-25 Fe₂O₃, the sum of BaO and SiO₂, constituting at least 72.5% of the batch; and at least one metal oxide selected from the group consisting of SrO, CaO, ZnO, MgO, Na₂O, K₂O, Rb₂O, Cs₂O wherein the ratio (MgO+ZnO+CaO+SrO)/BaO is ≤1; (b) simultaneously cooling the melt at least below the transformation point thereof and shaping a glass article therefrom; (c) heating the glass article between about 700° C. and 900° C. for a period of time sufficient to attain the desired crystallization, thereby forming a glass-ceramic article; and then (d) cooling the glass-ceramic article to room temperature.

According to some embodiments, a method of making the glass-ceramic article where in the crystal content thereof is at least 50% by weight of the a glass-ceramic article, wherein the crystal content comprises gillespite crystals that are all smaller than 50 microns in cross section (or diameter), and wherein BaFeSi₄O₁₀ constitutes the principal crystal phase, the method comprises: (a) melting a glass-forming batch consisting essentially, by mole on the oxide basis, of about 60-85 SiO₂, 4-30 BaO, 4-25 Fe₂O₃, the sum of BaO and SiO₂, constituting at least 72.5% of the batch; and up to 20% by mole total of at least one metal oxide selected from the group consisting of SrO, CaO, ZnO, MgO, Na₂O, K₂O, Rb₂O, Cs₂O wherein the ratio (MgO+ZnO+CaO+SrO)/BaO is ≤1 and the sum (Na₂O+K₂O+Rb₂O+Cs₂O) is 0-2 mole %; (b) simultaneously cooling the melt at least below the transformation point thereof and shaping a glass article therefrom; (c) heating the glass article between about 700° C. and 900° C. for a period of time sufficient to attain the desired crystallization, thereby forming a glass-ceramic article; and then (d) cooling the glass-ceramic article to room temperature.

According to some embodiments, a method of making the glass-ceramic article where in the crystal content thereof is at least 50% by weight of the a glass-ceramic article, wherein the crystal content comprises crystals that are all smaller than 50 microns in diameter, and wherein BaFeSi₄O₁₀ constitutes the principal crystal phase, the method comprises: (a) melting a glass-forming batch consisting essentially, by mole on the oxide basis, of about 65-75 SiO₂, 7.5-30 BaO, 4-12 Fe₂O₃, the sum of BaO and SiO, constituting at least 72.5% of the batch, and up to 20% by mole at least one metal oxide, selected from the group consisting of SrO, CaO, ZnO, MgO, Na₂O, K₂O, Rb₂O, and Cs₂O wherein the ratio (MgO+ZnO+CaO+SrO)/BaO is ≤1 and the sum (Na₂O+K₂O+Rb₂O+Cs₂O) is 0-2 mole. (b) simultaneously cooling the melt at least below the transformation point thereof and shaping a glass article therefrom; (c) heating the glass article between about 700° C. and 900° C. for a period of time sufficient to attain the desired crystallization, thereby forming a glass-ceramic article; and then (d) cooling the glass-ceramic article to room temperature.

According to some embodiments the time sufficient to attain the desired crystallization ranges about 2 to 6 hours (e.g., 2 hours, 2.5 hours, 3 hours, 3.5 hours, 4 hours, 4.5 hours, 5 hours, 5.5 hours, 6 hours, or therebetween).

According to some embodiments, the method(s) described above utilizing Pt as a nucleating agent. According to some embodiments, the method(s) described above utilizing reducing agent to the glass-forming batch. According to some embodiments, the reducing agent may be graphite, sugar, urea, silicon, or iron.

For example, we have discovered that certain glass compositions in the BaO—Fe₂O₃—SiO₂ glass-ceramic compositions, viz., within the composition range (mol %): 60-85 SiO₂, 4-BaO, 4-25 Fe₂O₃ with at least 2 ppm-mol Pt, as calculated from the batch on the oxide basis, when subjected to a controlled heat treating schedule will be converted into glass-ceramic bodies having the desirable physical and chemical properties recited above. The preferred compositions range generally within the 65-75 SiO₂, 5-30 BaO, 4-23 Fe₂O₃. It is preferable that the primary crystalline phase (i.e. >50% of crystals) comprises BaFeSi₄O₁₀. The phases obtained in the crystallization of the present glasses were observed utilizing X-ray diffraction analysis. According to the embodiments described herein, melting performed under conditions that results in the Fe redox ratio being >0.5. For example, according to one embodiment, the method of forming a glass-ceramic comprises melting a glass-forming batch containing about 65-75 SiO₂, 5-30 BaO, 4-23 Fe₂O₃, cooling this melt and forming a glass shape therefrom, and there after exposing this glass shape to a temperature between about 700° C.-900° C., and more preferably 750° C.-850° C. (e.g., 800° C.) for a time sufficient to attain the desired crystallization. In the exemplary embodiments described herein, the batch materials were dry mixed and melted in 600 gm batches in platinum crucibles with lids for about 2-4 hours at 1600° C. in electric furnaces. The melts poured upon a steel plate to form discs approximately 4-12inches in diameter and ¼ to ½inches thick. Some of cooled glass patties were then placed in an annealing oven at about 600° C. for one hour and cooled slowly to room temperature. Sections of the glass patties were thereafter transferred to a furnace and heated as described above to convert the glass to a glass-ceramic. Preferably, this ceramming process was done in a low oxygen partial pressure atmosphere, such as in nitrogen. Finally, the crystallized bodies (resultant glass-ceramics) were cooled to room temperature. I prefer to raise the temperature at 5° C./minute to the crystallization temperature, although more rapid rates, i.e., 6° C./minute and even higher (e.g., 7° C./minute, 8° C./minute, 9° C./minute, or 10° C./minute), can been used successfully. In the described examples, the heat to the electric furnace was simply cut off and the furnace allowed to cool to room temperature at its own rate (averaging about 3° C./minute). Much more rapid rates of cooling can be used without resulting in breakage, it being possible to take small articles directly out of the furnace after heat treatment and allowing them to cool in the air.

Tables 1 and 2 set forth examples of glasses having compositions within the above-recited ranges of the invention, calculated from their respective batches on the oxide basis in mole percent, exclusive of minor impurities which may be present in the batch materials. It will be appreciated that the batches may be composed of any materials, either oxides or other compounds, which on being melted homogeneously together are converted to the desired oxide compositions in the desired proportions. Tables 1 and 2 also record the crystal phase(s) present in each body, as determined by X-ray diffraction analysis. The samples were ground to a fine powder using a Rocklabs ring mill with WC heads for 30 seconds. The resulting powder was backfilled into stainless steel holders. The samples were measured on a Bruker D4 endeavor equipped with a Cu x-ray tube and a Lynx eye detector. They were scanned from 5-80 degrees 2-theta for a total time of 12 minutes. The resulting pattern was identified using the batch chemistry and the ICDD PDF-4 database. Table 3 records some measurements of Young's modulus and Shear modules (GPa.), coefficient of thermal expansion (ppm/° C.) and density (g/cc.) made on the bodies.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

1. A glass-ceramic with a phase assemblage comprising gillespite crystalline phase (BaFeSi₄O₁₀).

2. The glass-ceramic according to claim 1 comprising at least one of:
(a) barium silicate phase;
(b) silica crystalline phase;
(c) iron silicate phase.

3. The glass-ceramic according to claim 1, further comprising 2 to 100 ppm-mole Pt.

4. The glass-ceramic article of claim 1, comprising:
mol %-85 mol % SiO₂;
4 mol %-30 mol % BaO; and
4 mol %-30 mol % Fe₂O₃.

5. The glass-ceramic according to claim 1, wherein said glass-ceramic is an alkali-free glass-ceramic.

6. The glass-ceramic according to claim 1, wherein said glass-ceramic has a coefficient of thermal expansion that is less than 10 ppm/° C. at a temperature range between 25° C. and 300° C.

7. The glass-ceramic according to claim 6, wherein said glass-ceramic has a coefficient of thermal expansion that is less than 8.5 ppm/° C. at a temperature range between 25° C. and 300° C.

8. The glass-ceramic of claim 1 wherein the crystal content thereof comprises at least 50% by weight, wherein BaFeSi₄O₁₀ constitutes the principal crystal phase, the gillespite crystals being all smaller than about 50 microns in cross-section and being formed through the crystallization in situ of a glass body, the glass body comprising, by mole %, of: 60-85 SiO₂, 4-30 BaO, 4-25 Fe₂O₃, and at least one metal oxide from the group consisting of MgO, ZnO, CaO, and SrO, wherein the ratio (MgO+ZnO+CaO+SrO)/BaO is ≤1.

9. The glass-ceramic of claim 1, wherein the crystal content thereof comprises at least 75% by weight of the, wherein BaFeSi₄O₁₀ constitutes the principal crystal phase, the gillespite crystals being all smaller than about 50 microns in diameter and being formed through the crystallization in situ of a glass body, the glass body consisting essentially, by mole %, of 60-85 SiO₂, 4-30 BaO, 4 -25 Fe₂O₃, 60-85 SiO₂, 4-30 BaO, 4-25 Fe₂O₃, and at least one metal oxide from the group consisting of MgO, ZnO, CaO, and SrO, wherein the ratio (MgO+ZnO+CaO+SrO)/BaO is ≤1.

10. The glass-ceramic of claim 9, wherein all of the gillespite crystals in the crystal content are smaller than 30 microns in diameter.

11. The glass-ceramic of claim 10, wherein the gillespite crystals in said crystal content are 5 to 20 microns in diameter.

12. The glass-ceramic of claim 1, wherein the crystal content thereof comprises at least 50% by weight of the article, wherein BaFeSi₄O₁₀ constitutes the principal crystal phase, the gillespite crystals being all smaller than about 50 microns in cross-section and being formed through the crystallization in situ of a glass body; the glass body comprising by mole %, of: (i) 65-75 SiO₂, 7.5-30 BaO, 4-25 Fe₂O₃, wherein the sum of said BaO and SiO₂ constitutes at least 72.5% of said batch, (ii) at least one metal oxide from the group consisting of MgO, ZnO, CaO, and SrO, wherein the ratio (MgO+ZnO+CaO+SrO)/BaO is ≤1; and (iii) 0-2% of other components.

13. A glass-ceramic comprising: (i) gillespite; and (ii) 60-75 mol % SiO₂, 2-28 mol % BaO, and 4-28 mol % Fe₂O₃.

14. The glass-ceramic according to claim 1, comprising 4-20 mol % Fe₂O₃.

15. The glass-ceramic according to claim 1 comprising SiO₂, BaO, Fe₂O₃, and one or more of MgO, ZnO, CaO, SrO, or B₂O₃, in which gillespite is one of the crystalline phases.

16. The glass-ceramic according to claim 1 in which the molar ratio of MgO:BaO is ≤0.55.

17. The glass-ceramic according to claim 1 in which the molar ratio of ZnO:BaO is ≤0.45.

18. The glass-ceramic according to claim 1, in which the molar ratio of CaO:BaO is ≤1.

19. The glass-ceramic according to claim 1 in which the molar ratio of SrO:BaO is ≤1.

20. The glass-ceramic according to 1, in which the concentration of B₂O₃ (mol %) is ≤10.

21. A pigment comprising the glass-ceramic according to claim 1.

22. A method of making the glass-ceramic of claim 1, the method comprising utilizing a precursor glass, wherein the [Fe²⁺]/[total Fe] ratio of the precursor glass is in the range 0.5-1.

23. A method for making a glass-ceramic article where in the crystal content thereof is at least 50% by weight of the a glass-ceramic, wherein the crystal content comprises crystals that are all smaller than 50 microns in diameter, and wherein BaFeSi₄O₁₀ constitutes the principal crystal phase, the method comprises: (a) melting a glass-forming batch consisting essentially, by mole on the oxide basis, of about 65-75 SiO₂, 7.5-30 BaO, 4-12 Fe₂O₃, the sum of said BaO and SiO, constituting at least 72.5% of said batch, and up to 20% by mole total of at least one metal oxide selected from the group consisting of SrO, CaO, ZnO, MgO, Na₂O, K₂O, Rb₂O, Cs₂O wherein the ratio (MgO+ZnO+CaO+SrO)/BaO is ≤1 and the sum (Na₂O+K₂O+Rb₂O+Cs₂O) is 0-2 mole %; (b) simultaneously cooling the melt at least below the transformation point thereof and shaping a glass article therefrom; (c) heating said glass article between about 700° C. and 900° C. for a period of time sufficient to attain the desired crystallization, thereby forming a glass-ceramic article; and then (d) cooling said glass-ceramic article to room temperature.

24. A method according to claim 22 wherein said time sufficient to attain the desired crystallization ranges about 2 to 6 hours.

25. A method according to claim 23 wherein said time sufficient to attain the desired crystallization ranges about 4 hours.

26. A method according to claim 22, further comprising utilizing Pt as a nucleating agent.

27. The method of claim 22, further comprising adding a reducing agent to the glass-forming batch.

28. The method of claim 27 wherein the reducing agent is graphite, sugar, urea, silicon, or iron.
